(19) United States
(12) Patent Application Publication
(10) Pub. No.: US 2011/0127350 A1
(43) Pub. Date: Jun. 2, 2011

(54) Compression sprayer with pressure indicator

(76) Inventors: Wayne J. Beisssel, Hastings, MN (US); Dave Malm, Apple Valley, MN (US); Bill Blair, Holland, MI (US); Tim Bindon, Fennville, MI (US)

(21) Appl. No.: 12/627,001

(22) Filed: Nov. 30, 2009

(51) Int. Cl. B05B 15/00

(52) U.S. Cl. 239/71

(57) ABSTRACT

A new compression sprayer use a pop-up pressure gauge that has a transition piece that fits in a port on the tank. Threads on the transition piece hold it in place. The plunger cap that moves within the central passage is connected to a post, and is biased proximally by a spring that surrounds the post. The spring is held in place by a cover that is connected to the transition piece by interaction between a lock and a locking face. The distal end of the post serves as a pressure indicator, and may have a lateral lower surface that seats against the cap when the plunger cap is in a proximal position. One version of the plunger cap has a rigid proximal face that is integrally molded with the post, and has an o-ring that seals against the passage.

### CROSS-REFERENCE TO RELATED APPLICATIONS

Not applicable.

### BACKGROUND OF THE INVENTION

The present invention relates generally to sprayers and more particularly to compression sprayers that have a tank and a pump that a user can use to pressurize the contents of a tank to power the sprayer.

Compression sprayers have been known for years. One longstanding problem has been recurring uncertainty of the user about whether the tank has been sufficiently pressurized. This uncertainty can lead to over-pressurization of the tank, which can cause damage.

While simple pressure gauges have been known for years, they have not successfully incorporated into compression sprayers. A typical tire pressure gauge, for example, has a small, tight-sealing plunger cap fitted in a smooth tube. The plunger cap is commonly made of soft rubber and seals against the tube, which may be lubricated with a light oil to improve the seal. A stop is provided opposite the seal, and a spring runs the length of the tube between the plunger cap and the stop. The spring biases the plunger cap toward one side of the tube.

When the pressure gauge is placed on the valve stem of a tire, pressurized air from the tire flows into the cylinder and pushes the plunger cap toward the opposite side of the tube. The distance the plunger cap travels is proportional to the pressure in the tire. The gauge is designed to have a maximum pressure reading (such as 60 psi) and the spring is calibrated so that the desired maximum pressure moves the plunger cap all the way to a far side of the tube. When the gauge is released from the valve stem, the flow of pressurized air stops and the spring pushes the plunger cap back to its initial position.

A calibrated rod inside the tube enables the user to read the pressure. The rod generally fits inside the spring, with one end of the rod against, but not connected to, the plunger cap. When the plunger cap moves away from its initial position, it pushes the calibrated rod. The greater the pressure, the farther the rod moves. When the pressure is released, the plunger cap moves back to its initial position but the rod stays in place, enabling the user to move the gauge away from the tire and still read the pressure.

Although there has been a long-felt need to provide users of compression sprayers with a pressure indicator, to date no one has successfully and economically adapted the mechanics of a simple known pressure gauge for use in a compression sprayer.

### BRIEF SUMMARY

The applicants have developed a simple and economical pop-up gauge that can be incorporated into a compression sprayer. Like prior known sprayers, the new sprayer has a tank that holds a liquid. The sprayer has an inlet though which liquid is delivered to the tank. There is an outlet through which liquid in the tank can be sprayed, and a pump that can be used to pressurize the contents of the tank.

Like prior known tire pressure gauges, the pressure gauge in the new device has a central passage and a plunger cap seat that adjoins the passage near a proximal end of the device (i.e., the end toward the tire or the tank), and faces distally (i.e., away from the tire or the tank). A plunger cap is arranged to move proximally and distally within the central passage, and seals against the surface of the passage, blocking air flow between the plunger cap and the central passage. A coil spring is seated between the plunger cap and an opposed wall at the distal end of the gauge. The spring biases the plunger cap proximally. A post extends proximally from the plunger cap and through a central opening in the opposed wall. A pressure indicator is provided on its distal end.

Unlike any prior known pump sprayer or tire pressure gauge, the central passage in the new pump sprayer is positioned in a removable transition piece that has threads that mate with the threads on a separate port on the tank and enable the transition piece to be selectively secured to the tank. A cover is connected to the transition piece by a lock that extends radially outwardly from arms on a collar on the cover and fits against a proximal-facing locking face that extends outwardly from a section of the central passage on the transition piece. The post is physically connected to the plunger cap, and the indicator may have a lateral lower surface that seats against the cover when the plunger cap is in a proximal position.

### BRIEF DESCRIPTION OF THE DRAWINGS

The invention may be better understood by referring to the accompanying drawings, in which:

FIG. 1 is a perspective view of a sprayer that has the new pressure gauge.

FIG. 2 is an isometric view of the pressure gauge on the sprayer.

FIG. 3 is an enlarged partial cross-section of an alternate embodiment of the pressure gauge.

FIG. 4 is a rotated cross section of the version of the pressure gauge seen in FIG. 2.

FIG. 5 is a top plan view of the pressure gauge seen in FIG. 3.

### DETAILED DESCRIPTION

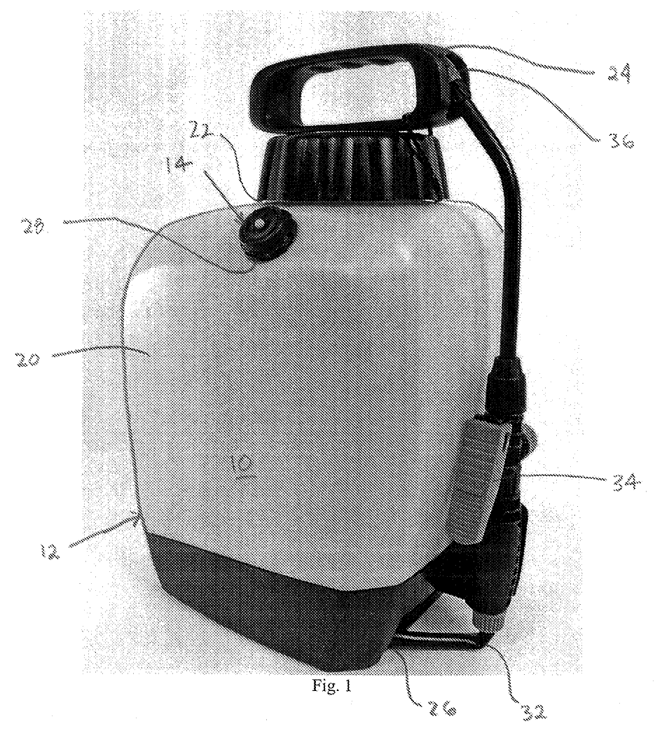

FIG. 1 illustrates one embodiment of a compression sprayer that uses the new arrangement. The illustrated sprayer 10 has a sprayer body 12 and a new pressure gauge 14. Each part will be discussed in turn.

### The Sprayer Body

Although the invention can also be used in other sprayers, the illustrated sprayer body 12 is a sprayer body used for compression sprayers for home and garden use. It has a tank 20, an inlet 22, a pump 24, an outlet 26, and a port 28.

The tank 20 holds a liquid. The illustrated tank is made of molded plastic and has a capacity ranging from ½ gallon to 3 gallons. Larger or smaller tanks can also be used.

The inlet 22 on the tank 20 enables an operator to fill the tank with liquid. The illustrated inlet is a conventional round threaded inlet that has a diameter ranging from 2″ to 10″ in diameter. Other types of inlets can also be used.

The pump 24 is used to pressurize the contents of the tank 20. Many different types of pumps can be used, and the illustrated pump is a conventional manual pump that is connected to the inlet 22 and pumps air directly into the tank.

The outlet 26 is where pressurized liquid exits the tank 20. The illustrated outlet is a conventional connection to a hose 32. A conventional trigger 34 and a conventional nozzle 36 on the hose enable the user to adjust and direct the flow of pressurized liquid as desired. In some cases, a single aperture can be used both as the inlet and the outlet.

The illustrated port 28 is an opening where the pressure gauge is mounted. The illustrated port is an opening between 1″ and 8″ in diameter. The illustrated port is separate from the illustrated inlet 22 and the illustrated outlet 26, but in other embodiments it could be part of the inlet or the outlet. Larger or smaller openings might also be used. Internal threads on the illustrated port have a pitch of between 0.25″ and 1″.

### The Pressure Gauge

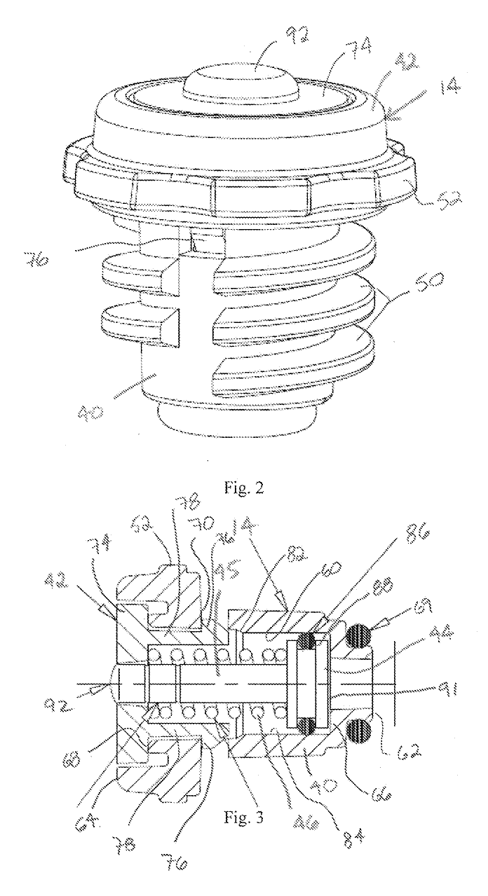

The new pressure gauge 14, best seen in FIGS. 2-5, enables a user to assess whether the contents of the tank 20 are adequately pressurized. The gauge has a removable transition piece 40, a cover 42, a plunger cap 44, a post 45, and a spring 46. Each of these parts will be discussed in turn.

The transition piece 40 fits on the port 28 on the sprayer body 12 and forms the main body of the pressure gauge 14.

To enable the transition piece 40 to fit on the port 28, the illustrated transition piece has external threads 50 that mate with the threads on the port. In this example, the threads on the transition piece are external threads that have the same pitch as the threads on the port. Other arrangements can also be used. For example, the sprayer body 12 could be provided with a neck that extends outwardly from the tank 20 and has external threads. For such a tank, the transition piece could have internal threads, rather than external threads.

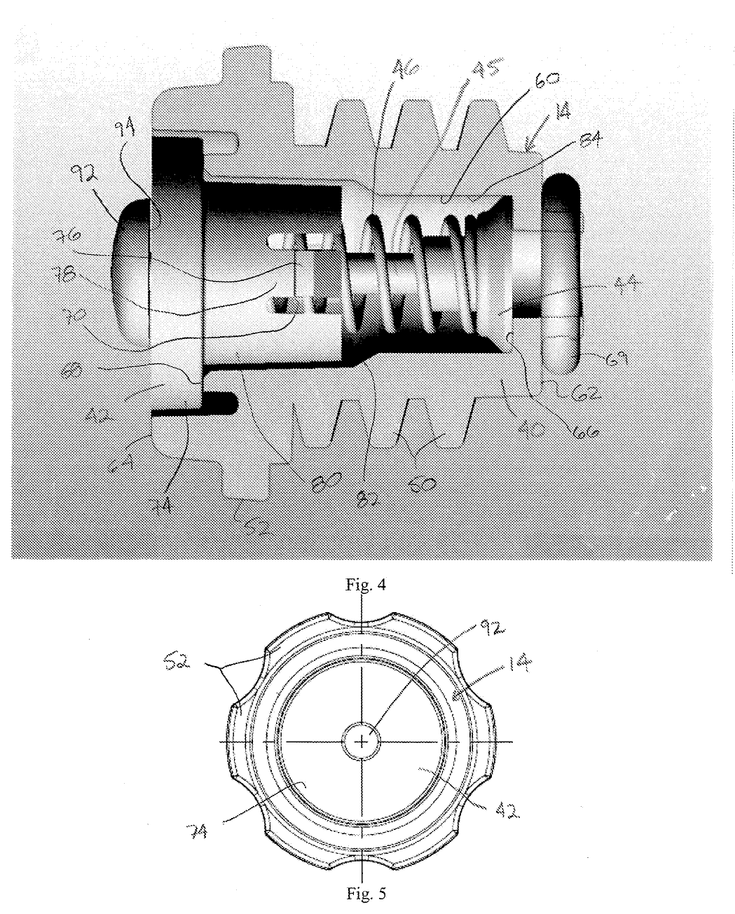

To facilitate the connection and removal of the transition piece 40 on the port 22, the illustrated transition piece has optional finger grips 52 (FIGS. 1 and 5) around its periphery. The illustrated finger grips extend between ¼″ and 1″ radially outwardly. Other arrangements are also possible.

To enable the transition piece to function as the main body of the pressure gauge 14, the illustrated transition piece 40 has a central passage 60 that extends from a proximal end 62 of the transition piece (toward the tank) to a distal end 64 of the transition piece (away from the tank). The illustrated transition piece is made of molded plastic, but other materials can also be used. Although other arrangements are possible, the illustrated central passage has a linear central axis and a circular cross section, and is between ¼″ and 2″ in length from the proximal end to the distal end. A plunger seat 66 adjoins the passage, near the proximal end, and faces distally. Although other arrangements are possible, the illustrated plunger seat is annular in shape and has a planar edge that is between ⅛″ and ¾″ wide. Near the distal end of the transition piece, a cover seat 68 adjoins the central passage. The illustrated cover seat is also annular and is between 1/16″ and ½″ wide. Although other arrangements are possible, the illustrated cover seat is generally planar and faces distally.

An optional resilient seal 69 on the proximal end 62 of the transition piece 40 engages the port 22 on the tank 20 when the transition piece is secured in the port. This seal limits flow through the port to flow into the central passage 60. Other arrangements can also be used.

On the illustrated transition piece 40, two locking faces 70 extend outwardly from a section of the central passage 60 (FIGS. 3 and 4) between the plunger seat 66 and the cover seat 68. These locking faces interact with locks described below to hold the cover 42 and the transition piece together. Wide variation in the arrangement the locking faces and the locks are possible. The illustrated locking faces extend between 1/32″ and ¼″ radially outward from the central passage. Together, the edges of these locking faces that border the central passage traverse between 2 degrees and 180 degrees of the circumference of the central passage. Preferably, two or more locking faces are used, and are spaced around the periphery of the central passage.

The cover 42 fits onto the transition piece 40. The illustrated cover is made of plastic and has a flange 74 that seats on the cover seat 68 on the transition piece. The illustrated flange is between 1/32″ and ¼″ in thickness, and has an outer diameter of between ½″ and 4″. On opposite lateral sides of the illustrated cover, two locks 76 extend radially outwardly from arms 78 on a collar 80 (FIG. 4) that descends from the flange. Each lock fits against one of the locking faces 70, connecting the cover to the transition piece. Although the illustrated sprayer 10 has its locks on the cover and its locking faces on the transition piece, locks could be positioned on the transition piece, with corresponding locking faces on the cover.

To make room for the arms 78 on the cover 42, the cross section of the central passage 60 in the transition piece 40 is wider near the distal end 64 than near the proximal end 62. In this example, the central passage has a bevel section 82 that flares outwardly from a cylindrical lower section 84, and the locking faces 70 are located distally of the bevel section.

The plunger cap 44 fits within a portion of the central passage 60 between the plunger seat 66 and the cover 42. In the illustrated example, the plunger cap fits in the cylindrical lower section 84 of the central passage. The plunger cap is arranged to move proximally and distally within the central passage. In its most proximal position, the plunger cap seats against the plunger seat 66. In the arrangement seen in FIG. 4, the plunger cap is made of a soft material but is rigid enough to block flow between the plunger cap and the central passage. The plunger cap in the pressure gauge seen in FIG. 4 is made from soft molded rubber or rubber-like material and has a circular cross section. In other embodiments, other materials and cross sections can be used. In the embodiment seen in FIG. 3, for example, the plunger cap is made of a more rigid material and has a resilient o-ring 86 that fits in a peripheral channel 88 behind the proximal face and provides the seal against the surface of the passage.

The post 45 extends proximally from the plunger cap 44 and through a central opening on the cover 42. The post is connected to the plunger cap 44. In the sprayer seen in FIG. 4, the post is made of rigid plastic and is secured in a sleeve 90 on the distal side of the plunger cap. In the sprayer seen in FIG. 3, the post may be integrally molded with proximal surface 91 of the plunger cap.

An indicator 92 is provided on a distal end of the post 45, outside the cover 42. In the pressure indicator seen in FIG. 4, the indicator is in the form of a head that has an optional lateral lower surface 94 that seats against the cover when the plunger cap 44 is in a proximal position.

The spring 46 is seated between the plunger cap 44 and the cover 42 and biases the plunger cap toward the plunger seat 66. The illustrated spring is a wire coil spring that is selected and configured so that the plunger cap begins to move away from the cover seat under a pressure of 5 psi on the proximal side 91 of the plunger cap 44, and moves to a distal position under a pressure of 10 psi. In the pressure indicator seen in FIG. 3, this movement raises the distal end of the indicator 92 outwardly beyond the cap, providing a visual indication of the pressure in the tank 20. In the pressure indicator seen in FIG. 4, pressure on the proximal side of the plunger cap raises the lateral lower surface 94 of the indicator noticeably above the cover, again providing a visual indication to the user that the tank is adequately pressurized. Other arrangements may be used in other embodiments of the invention.

When pressurization in the tank 20 decreases, the combination of the force of the spring 46 on the plunger cap 44 and the connection of the plunger cap to the post 45 automatically pushes the post 45 back towards the plunger seat 66 and pushes the indicator 92 back toward the cover 42, providing a visual indication to the user that more pressure may be desired.

This description of various embodiments of the invention has been provided for illustrative purposes. Revisions or modifications may be apparent to those of ordinary skill in the art without departing from the invention. The full scope of the invention is set forth in the following claims.

1. A sprayer that has:
a tank that holds a liquid;
a nozzle through which liquid in the tank can be sprayed;
a pump that can be used to pressurize the contents of the tank;
a port that opens to the tank;
threads on the port;
a removable transition piece that has threads that mate with the threads on the port and enable the transition piece to be selectively secured to the port;
a central passage that extends from a proximal end of the transition piece to a distal end of the transition piece;
a plunger seat that adjoins the passage, near the proximal end, and faces distally;
a cover seat that adjoins the passage, near the distal end;
a cover that is connected to the transition piece and seats against the cover seat;
a plunger cap that fits within a portion of the central passage between the plunger seat and the cover, is arranged to move proximally and distally within the central passage, and seals against the surface of the passage, blocking flow between the plunger cap and the central passage;
a spring that is seated between the plunger cap and the cover and biases the plunger cap towards the plunger seat;
a post that extends from the plunger cap and through a central opening on the cover; and
an indicator on a distal end of the post.

2. A sprayer as recited in claim 1, in which:
at least one locking face extends outwardly from a section of the central passage between the plunger seat and the cover seat and faces proximally; and
a lock extends radially outwardly from cover and fits against the locking face, connecting the cover to the transition piece.

3. A sprayer as recited in claim 1, in which the sprayer also has:
a resilient seal on the transition piece that engages the port when the transition piece is secured in the port and limits flow through the port to flow into the central passage.

4. A sprayer as recited in claim 1, in which:
the indicator has a lateral lower surface that seats against the cover when the plunger cap is in a proximal position.

5. A sprayer as recited in claim 1, in which the plunger cap has:
a rigid proximal face that is integrally molded with the post; and
an o-ring that seats in a channel behind the proximal face and provides the seal against the surface of the passage.

6. A sprayer as recited in claim 1, in which:
the pump is a manual pump;
the post is connected to the plunger cap;
the transition piece has a seal that engages the port when the transition piece is secured in the port and limits flow through the port to flow into the central passage; and
the indicator has a lateral lower surface that seats against the cover when the plunger cap is in a proximal position.

7. A sprayer that has:
a tank that holds a liquid;
a nozzle through which liquid in the tank can be sprayed;
a pump that can be used to pressurize the contents of the tank;
a port that opens to the tank;
threads on the port;
a removable transition piece that has threads that mate with the threads on the port and enable the transition piece to be selectively secured to the port;
a central passage that extends from a proximal end of the transition piece to a distal end of the transition piece;
a plunger seat that adjoins the passage, near the proximal end, and faces distally;
a cover seat that adjoins the passage, near the distal end, and faces distally;
a cover that is connected to the transition piece and seats against the cover seat;
a plunger cap that fits within a portion of the central passage between the plunger cap seat and the cover, is arranged to move proximally and distally within the central passage, and seals against the surface of the passage, blocking flow between the plunger cap and the central passage;
a coil spring that is seated between the plunger cap and the cover and biases the plunger cap towards the plunger seat;
a post that is connected to the plunger cap and extends proximally from the plunger cap and through a central opening on the cover; and
an indicator on a distal end of the post.

8. A sprayer as recited in claim 7 in which:
at least one locking face extends outwardly from a section of the central passage between the plunger seat and the cover seat and faces proximally; and
a lock extends radially outwardly from cover and fits against the locking face, connecting the cover to the transition piece.

9. A sprayer as recited in claim 7 in which the sprayer also has:
a resilient seal on the transition piece that engages the port when the transition piece is secured in the port and limits flow through the port to flow into the central passage.

10. A sprayer as recited in claim 7 in which:
the indicator has a lateral lower surface that seats against the cover when the plunger cap is in a proximal position.

11. A sprayer as recited in claim 7, in which:
the pump is a manual pump; and
the indicator has a lateral lower surface that seats against the cover when the plunger cap is in a proximal position.

12. A sprayer as recited in claim 7, in which the plunger cap has:
a rigid proximal face that is integrally molded with the post; and
an o-ring that seats in a channel behind the proximal face and provides the seal against the surface of the passage.

13. A sprayer that has:
a tank that holds a liquid;
a nozzle through which liquid in the tank can be sprayed;
a pump that can be used to pressurize the contents of the tank;
a port that opens to the tank;
threads on the port;
a removable transition piece that has threads that mate with the threads on the port and enable the transition piece to be selectively secured to the port;
a central passage that extends from a proximal end of the transition piece to a distal end of the transition piece;
a plunger seat that adjoins the passage, near the proximal end, and faces distally;
a cover seat that adjoins the passage, near the distal end, and faces distally;
a cover that is connected to the transition piece and seats against the cover seat;
a plunger cap that fits within a portion of the central passage between the plunger seat and the cover, is arranged to move proximally and distally within the central passage, and seals against the surface of the passage, blocking flow between the plunger cap and the central passage;
a coil spring that is seated between the plunger cap and the cover and biases the plunger cap towards the plunger seat;
a post that extends proximally from the plunger cap and through an opening on the cover; and
an indicator on a distal end of the post.

14. A sprayer as recited in claim 13, in which:
at least one locking face extends outwardly from a section of the central passage between the plunger seat and the cover seat and faces proximally; and
a lock extends radially outwardly from cover and fits against the locking face, connecting the cover to the transition piece.

15. A sprayer as recited in claim 13, in which the sprayer also has:
a resilient seal on the transition piece that engages the port when the transition piece is secured in the port and limits flow through the port to flow into the central passage.

16. A sprayer as recited in claim 13, in which:
the indicator has a lateral lower surface that seats against the cover when the plunger cap is in a proximal position.

17. A sprayer as recited in claim 13, in which:
the pump is a manual pump; and
the indicator has a lateral lower surface that seats against the cover when the plunger cap is in a proximal position.

18. A sprayer as recited in claim 13, in which the plunger cap has:
a rigid proximal face that is integrally molded with the post; and
an o-ring that seats in a channel behind the proximal face and provides the seal against the surface of the passage.
